(19) United States
(12) Patent Application Publication
(10) Pub. No.: US 2017/0129336 A1
(43) Pub. Date: May 11, 2017

(54) VEHICULAR DISPLAY DEVICE

(71) Applicant: MAZDA MOTOR CORPORATION, Hiroshima (JP)

(72) Inventors: Seiji HISADA, Higashihiroshima-shi (JP); Shigeyuki SATO, Aki-gun (JP); Yo KITAMURA, Hiroshima-shi (JP); Hado MOROKAWA, Hiroshima-shi (JP); Hidehiko SODA, Hatsukaichi-shi (JP)

(73) Assignee: MAZDA MOTOR CORPORATION, Hiroshima (JP)

(21) Appl. No.: 15/319,106

(22) PCT Filed: Jan. 22, 2016
(86) PCT No.: PCT/JP2016/051896

§ 371 Date: Dec. 15, 2016

(30) Foreign Application Priority Data
Feb. 5, 2015 (JP) 2015-021089

(51) Int. Cl. B60K 35/00

(52) U.S. Cl. CPC B60K 35/00; B60K 2310/22; B60K 2350/206; B60K 2350/1064; B60K 2350/1084

(57) ABSTRACT

The present application discloses a vehicular display device mounted on a vehicle. The vehicular display device has a display panel including a display surface, on which an image is displayed, and a housing, which supports the display surface; and a first analog meter including a first frame curved in a direction away from the display surface between a first end and a second end, which are aligned along a boundary line between the display surface and the housing. The display panel displays a first frame image curved in a direction opposite to the first frame. The first frame image extends from the first end to the second end.

### TECHNICAL FIELD

The present invention relates to a vehicular display device.

### BACKGROUND ART

An analog meter including a rotary needle is widely used to transmit information to a driver, the information representing a running condition of a vehicle. In recent years, replacement of the analog meter with a display panel has been attempted in recent years to display the running condition of the vehicle as an image (c.f. Patent Document 1). Unlike the analog meter, the display panel may show a driver a variety of information.

Many drivers prefer displaying a running condition in a large display region. Therefore, if a display panel is used instead of an analog meter, a large display surface is required for the display panel. An expensive display panel may be required if a driver wants a display in a large display region since a size of a display surface directly affects a cost of the display panel in general.

### PATENT DOCUMENT

Patent Document 1: JP 2014-95602 A

### SUMMARY OF INVENTION

An object of the present invention is to provide a vehicular display device configured to display information in such a manner, which is familiar to a driver, with use of a display panel having a small display area.

A vehicular display device according to one aspect of the present invention is mounted on a vehicle. The vehicular display device has a display panel including a display surface, on which an image is displayed, and a housing, which supports the display surface; and a first analog meter including a first frame curved in a direction away from the display surface between a first end and a second end, which are aligned along a boundary line between the display surface and the housing. The display panel displays a first frame image curved in a direction opposite to the first frame. The first frame image extends from the first end to the second end.

The present invention provides a vehicular display device configured to display information in such a manner which is familiar to a driver with use of a display panel having a small display area.

These and other objects, features and advantages of the present invention will become more apparent upon reading the following detailed description along with the accompanying drawings.

### BRIEF DESCRIPTION OF DRAWINGS

FIG. 1 is a schematic exploded perspective view of a vehicular display device of the first embodiment;

FIG. 2 is a schematic front view of the vehicular display device shown in FIG. 1;

FIG. 3 is a schematic front view of the vehicular display device shown in FIG. 1 (the second embodiment);

FIG. 4 is a schematic front view of the vehicular display device shown in FIG. 1 (the third embodiment);

FIG. 5 is a schematic exploded perspective view of a vehicular display device of the fourth embodiment;

FIG. 6 is a schematic front view of the vehicular display device shown in FIG. 5;

FIG. 7 is a schematic front view of the vehicular display device shown in FIG. 5 (the fifth embodiment); and

FIG. 8 is a block diagram conceptually showing a signal flow in the vehicular display device depicted in FIG. 5 (the sixth embodiment).

### DESCRIPTION OF EMBODIMENTS

Various embodiments about a vehicular display device are described with reference to the accompanying drawings. With regard to the following embodiments, the same elements are indicated with the same reference numerals. To clarify the description, repeated description is omitted. Configurations, arrangements or shapes shown in the drawings and relevant descriptions to the drawings are provided merely for the purpose of making the principles of the following embodiments easily understood. Therefore, the principles of the following embodiments are not limited to these. The directional terms such as “up”, “down”, “left and “right” are provided merely for the purpose of clarifying the description. Therefore, these terms should not be construed restrictively.

### First Embodiment

The present inventors figured out that a display panel may not have to have an excessively large display area if an analog meter is used in combination with a display panel configured to display a variety of information. On the other hand, the inventors figured out a drawback that unified visual impressions of the display panel and the analog meter may be likely to be lost if the analog meter is used in combination with the display panel. A vehicular display device configured to provide a driver with unified visual impressions of a display panel and an analog meter is described in the first embodiment.

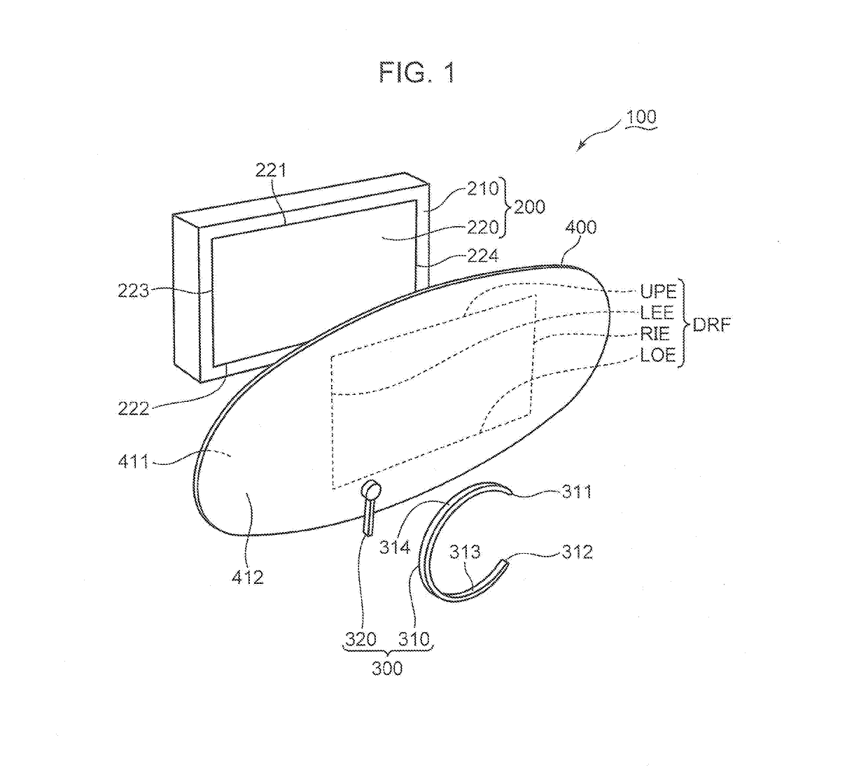

FIG. 1 is a schematic exploded perspective view of a vehicular display device (hereinafter, referred to as the display device 100) of the first embodiment. The display device 100 is described with reference to FIG. 1.

The display device 100 includes a display panel 200, an analog meter 300 and a dial plate 400. The display panel 200 includes a housing 210 and a display surface 220. The display surface 220 is supported by the housing 210. The display panel 200 displays an image on the display surface 220 in response to an image signal. The display panel 200 may be a liquid crystal display configured to drive liquid crystal and display an image. Alternatively, the display panel 200 may be a plasma display using plasma emission. Further alternatively, the display panel 200 may be an organic EL (electroluminescence) display using organic EL elements. The principles of the present embodiment are not limited to a specific type of the display panel 200.

The display surface 220 includes an upper edge 221, a lower edge 222, a left edge 223 and a right edge 224. The upper edge 221 extends horizontally. The lower edge 222 extends horizontally below the upper edge 221. The left edge 223 vertically extends from the left end of the upper edge 221 to the left end of the lower edge 222. The right edge 224 vertically extends from the right end of the upper edge 221 to the right end of the lower edge 222. The upper edge 221, the lower edge 222, the left edge 223 and the right edge 224 form a boundary line between the housing 210 and the display surface 220.

The dial plate 400 is situated between the display panel 200 and the analog meter 300. FIG. 1 shows a rectangular frame DRF in the dial plate 400. The rectangular frame DRF includes an upper edge UPE, a lower edge LOE, a left edge LEE and a right edge RIE. The upper edge UPE substantially coincides with the upper edge 221 of the display surface 220. The lower edge LOE substantially coincides with the lower edge 222 of the display surface 220. The left edge LEE substantially coincides with the left edge 223 of the display surface 220. The right edge RIE substantially coincides with the right edge 224 of the display surface 220.

The region surrounded by the rectangular frame DRF allows transmittance of image light emitted from the display surface 220. The region outside the rectangular frame DRF may be opaque. The dial plate 400 may include a gradation pattern along the rectangular frame DRF. In this case, the boundary between the housing 210 and the display surface 220 is blurred by the gradation pattern. Accordingly, it is less likely that a driver visually recognizes the boundary between the housing 210 and the display surface 220.

The dial plate 400 includes a first surface 411 and a second surface 412. The first surface 411 faces the display panel 200. The analog meter 300 is mounted on the second surface 412 opposite to the first surface 411. Image light emitted from the display surface 220 is incident to the first surface 411, and then emitted from the second surface 412. The image light emitted from the second surface 412 is eventually incident to the driver's eyes. Therefore, the driver may visually recognize an image which is displayed on the display panel 200.

The analog meter 300 includes a C-shaped ring 310 and a pointing needle 320. The C-shaped ring 310 and the pointing needle 320 are mounted on the second surface 412 of the dial plate 400. Indexes (not shown, for instance, scale lines or numbers) representing a running condition (such as a vehicular speed, an engine speed, water temperature, or an amount of remaining fuel) of a vehicle on which the display device 100 is mounted may be drawn on the dial plate 400. The C-shaped ring 310 surrounds the indexes drawn on the dial plate 400.

The pointing needle 320 is rotated on the second surface 412 of the dial plate 400. Various mechanisms used in general analog meters may be used for rotating the pointing needle 320. Therefore, the principles of the present embodiment are not limited to a specific mechanism for rotating the pointing needle 320.

The C-shaped ring 310 includes an upper end 311 and a lower end 312. The lower end 312 is spaced below from the upper end 311.

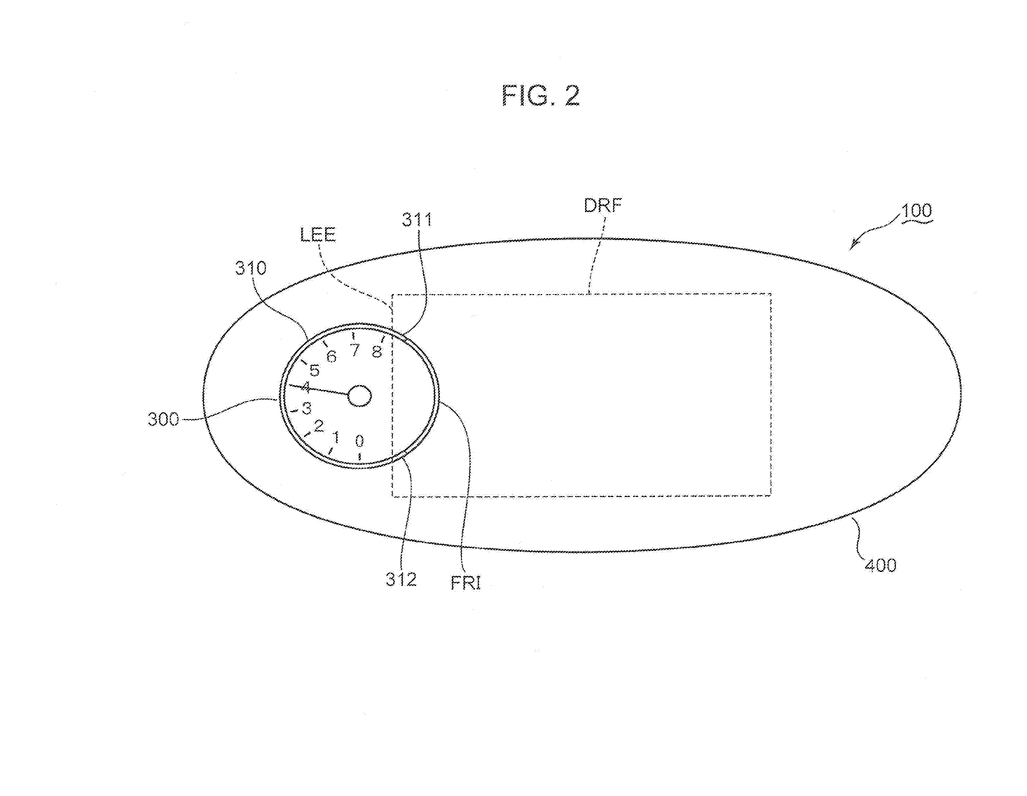

FIG. 2 is a schematic front view of the display device 100. The display device 100 is further described with reference to FIGS. 1 and 2.

The upper and lower ends 311, 312 of the C-shaped ring 310 are aligned along the left edge LEE of the rectangular frame DRF, which corresponds to the display surface 220 (c.f. FIG. 1) of the display panel 200. The C-shaped ring 310 is curved in a direction away from the rectangular frame DRF (i.e. toward the leftward) between the upper and lower ends 311, 312. With regard to the present embodiment, the first analog meter is exemplified by the analog meter 300. The first frame is exemplified by the C-shaped ring 310. The first end is exemplified by one of the upper and lower ends 311, 312. The second end is exemplified by the other of the upper and lower ends 311, 312.

The display panel 200 displays a frame image FRI. The frame image FRI is curved in a direction opposite to the C-shaped ring 310 (i.e. rightward). The frame image FRI extends from the upper end 311 of the C-shaped ring 310 to the lower end 312 of the C-shaped ring 310. Therefore, the frame image FRI forms a closed loop in cooperation with the C-shaped ring 310. The driver may watch information displayed in the closed loop to confirm a running condition of the vehicle. With regard to the present embodiment, the first frame image is exemplified by the frame image FRI.

As described above, with regard to the present embodiment, the first frame is exemplified by the C-shaped ring 310 which forms a C-shaped arcuate contour. Alternatively, a designer designing a vehicular display device may provide another shape (e.g. a curved shape constituted by short line segments) to the first frame. Therefore, the present embodiment is not limited to a specific shape of the first frame.

As described above, the first end is exemplified by one of the upper and lower ends 311, 312 whereas the second end is exemplified by the other of the upper and lower ends 311, 312. As shown in FIG. 2, the upper and lower ends 311, 312 are situated in the rectangular frame DRF, which corresponds to the display surface 220. Alternatively, the first frame may be situated so that at least one of the first and second ends is deviated from the display surface 220. The expression “the first and second ends are aligned with the boundary line” means that both of the first and second ends are situated near the boundary line. Therefore, the expression “the first and second ends are aligned with the boundary line” may mean that the first and second ends are close to the boundary line to such an extent that a driver is given visual impressions that the first frame forms a closed loop in cooperation with the frame image FRI. The principles of the present embodiment are not limited to a specific positional relationship among the boundary line, the first end and the second end.

As shown in FIG. 1, the analog meter 300 is mounted on the oval dial plate 400. A designer designing a vehicular display device may use another fixing member instead of the dial plate 400. For instance, the analog meter 300 may be mounted on a member, which does not cover the display surface 220 of the display panel 200. Therefore, the principles of the present embodiment are not specifically limited by the dial plate 400.

### Second Embodiment

As described in the context of the first embodiment, the first frame image forms a closed loop in cooperation with the first frame. The display panel may display a meter image representing a running condition of a vehicle in the closed loop. The meter image may represent information different in contents from information given to a driver by the first analog meter. Alternatively, the meter image may provide information about a running condition of the vehicle in cooperation with the first analog meter. A vehicular display device for displaying a meter image in addition to the first frame image is described in the second embodiment.

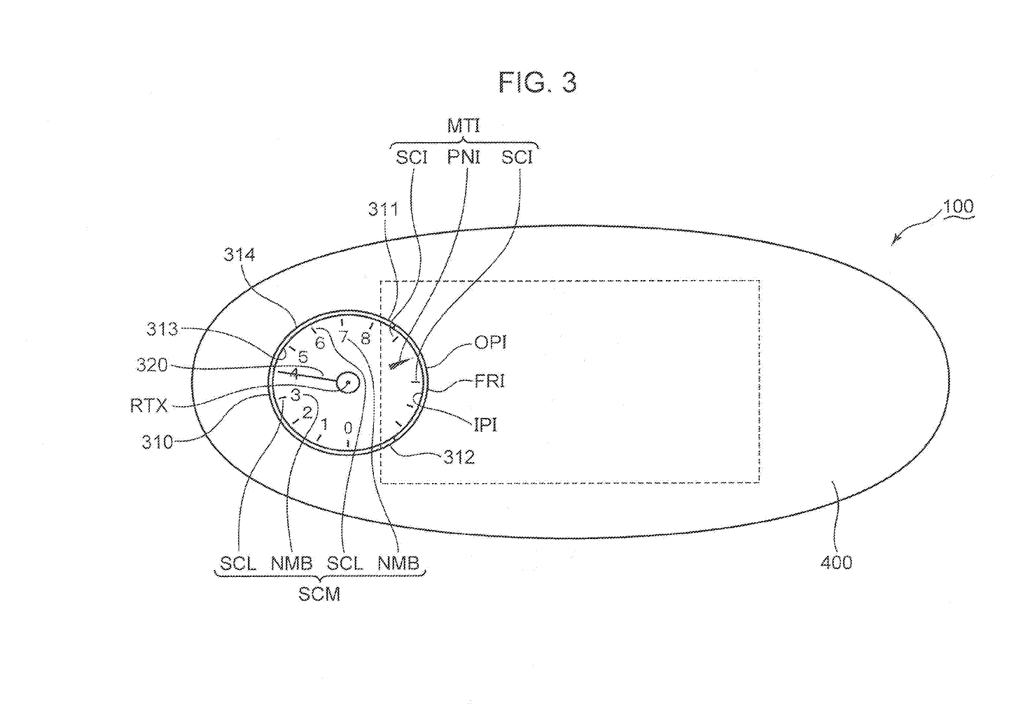

FIG. 3 is a schematic front view of the display device 100. The reference numerals used in common between the first and second embodiments mean that elements indicated with the same reference numerals have the same functions as the first embodiment. Therefore, the description of the first embodiment is applicable to these elements. The display device 100 is described with reference to FIGS. 1 and 3.

Indexes SCM representing a running condition (such as a vehicular speed, an engine speed, water temperature, or an amount of remaining fuel) of a vehicle are drawn on the dial plate 400. The indexes SCM include scale lines SCL and numbers NMB.

The C-shaped ring 310 includes an inner edge 313 and an outer edge 314. The inner edge 313 forms an arcuate contour between the upper and lower ends 311, 312. The outer edge 314 forms an arcuate contour between the upper and lower ends 311, 312 outside the inner edge 313.

The scale lines SCL are aligned along the inner edge 313 substantially at regular intervals. Each of the scale lines SCL extends toward a rotation axis RTX of the pointing needle 320. Each of the numbers NMB is arranged in correspondence to each of the scale lines SCL. A driver may watch a value designated by the pointing needle 320 to confirm a running condition (such as a vehicular speed, an engine speed, water temperature, or an amount of remaining fuel) of the vehicle.

The display panel 200 displays a meter image MTI in addition to the frame image FRI. The meter image MTI includes scale line images SCI and a pointing needle image PNI. The frame image FRI includes an inner perimeter image IPI and an outer perimeter image OPI. The inner perimeter image IPI is curved in a direction opposite to the C-shaped ring 310 between the upper and lower ends 311, 312. The outer perimeter image OPI is curved in a direction opposite to the C-shaped ring 310 between the upper and lower ends 311, 312 outside the inner perimeter image IPI.

The scale line images SCI are aligned along the inner perimeter image IPI substantially at regular intervals. Each of the scale line images SCI extends toward the rotation axis RTX of the pointing needle 320. The pointing needle image PNI circularly moves along the inner perimeter image IPI in response to a running condition of the vehicle. The driver may confirm the running condition of the vehicle on the basis of a position of the pointing needle image PNI.

### Third Embodiment

As described in the context of the first embodiment, the first frame image is displayed near the boundary line of the display surface. Therefore, a display panel has a large display region adjacent to a region for displaying the first frame image. A vehicular display device for displaying a meter image in a region adjacent to a region for displaying the first frame image is described in the third embodiment.

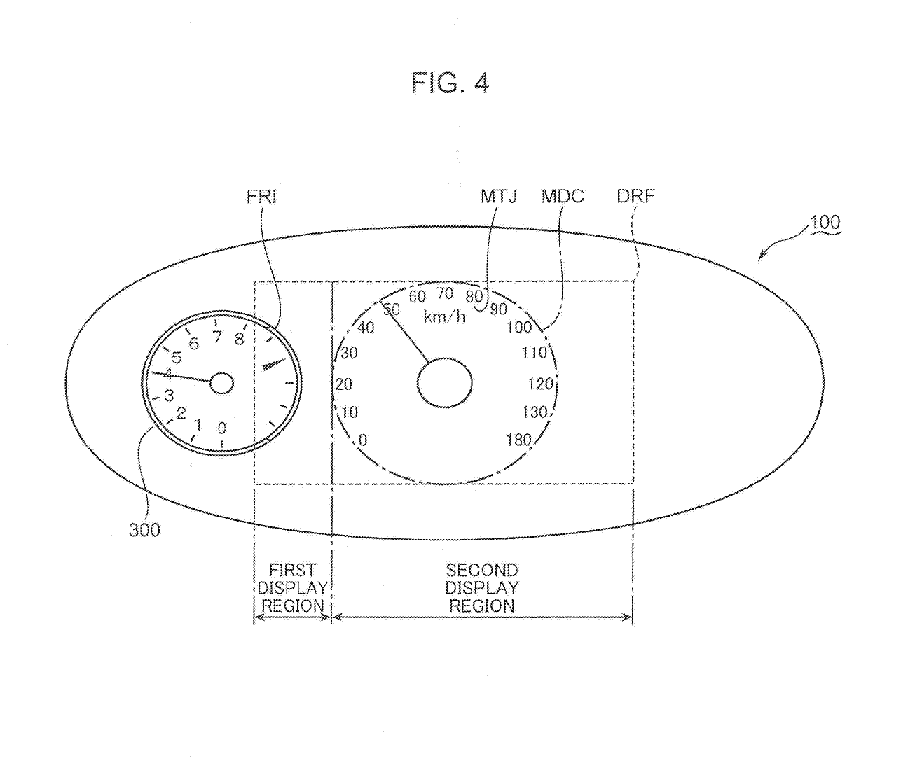

FIG. 4 is a schematic front view of the display device 100. The reference numerals used in common between the second and third embodiments mean that elements indicated with the same reference numerals have the same functions as the second embodiment. Therefore, the description of the second embodiment is applicable to these elements. The display device 100 is described with reference to FIGS. 1 and 4.

FIG. 4 conceptually divides a region surrounded by the rectangular frame DRF, which corresponds to the boundary of the display surface 220 (c.f. FIG. 1), into a first display region and a second display region. The frame image FRI is displayed in the first display region. The second display region is situated adjacent to the first display region.

FIG. 4 shows a conceptual circle MDC by one-dotted chain line. The circle MDC forms a closed loop in the second display region. The display panel 200 displays a meter image MTJ in the circle MDC. The meter image MTJ may provide a driver with information different in contents from information given to the driver by the analog meter 300. For instance, the analog meter 300 may provide the driver with information about an engine speed, water temperature or an amount of remaining fuel when the meter image MTJ in the circle MDC represents a vehicular speed. With regard to the present embodiment, the meter display region is exemplified by the region surrounded by the circle MDC.

### Fourth Embodiment

A designer may design various vehicular display devices on the basis of the design principles described in the context of the first to third embodiments. For instance, the designer may provide a vehicular display device with a design analogous to a design of a general meter device, in which three analog meters are sequentially arranged. An exemplary vehicular display device is described in the fourth embodiment.

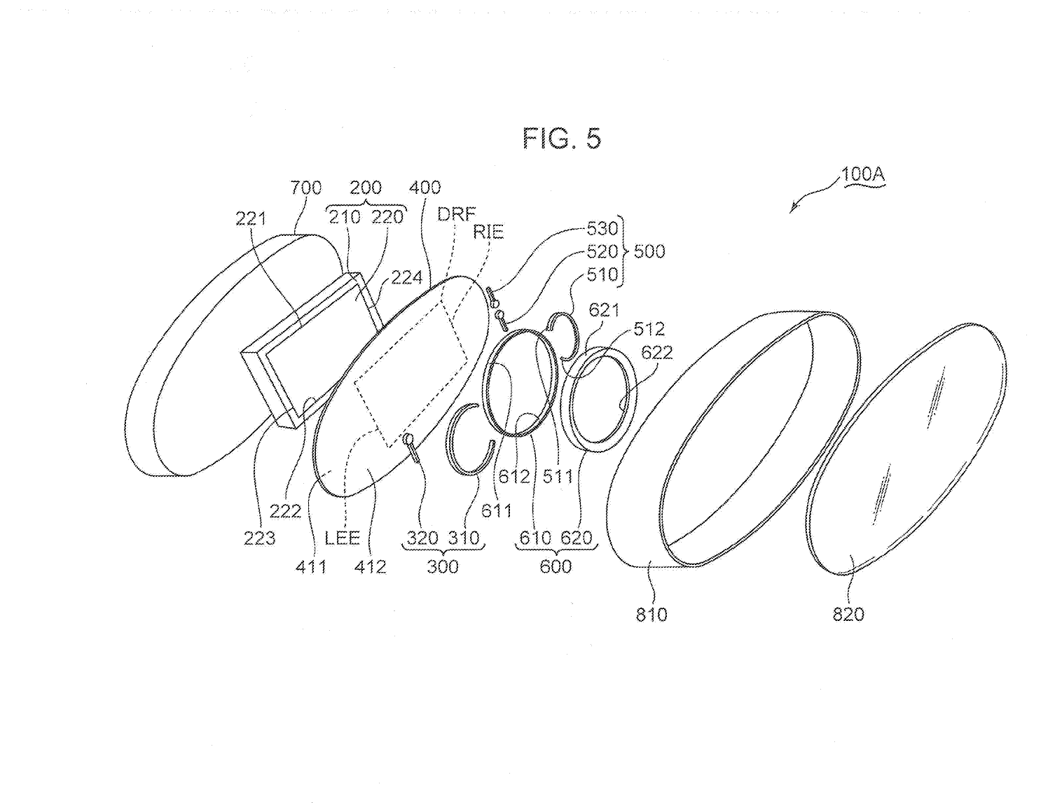

FIG. 5 is a schematic exploded perspective view of a vehicular display device (hereinafter, referred to as the display device 100A) of the fourth embodiment. The reference numerals used in common among the first to fourth embodiments mean that elements indicated with the same reference numerals have the same functions as the first to third embodiments. Therefore, the descriptions of the first to third embodiments are applicable to these elements. The display device 100A is described with reference to FIGS. 4 and 5.

Like the third embodiment, the display device 100A includes the display panel 200, the analog meter 300 and the dial plate 400. The description of the third embodiment is applicable to these elements.

The display device 100A further includes an analog meter 500, a circular ring 600, a drive unit 700, a meter vessel 810 and a protection plate 820. Like the analog meter 300, the analog meter 500 is mounted on the second surface 412 of the dial plate 400. The analog meter 500 is situated on the right side of the analog meter 300. With regard to the present embodiment, the second analog meter is exemplified by the analog meter 500.

The analog meter 500 includes a C-shaped ring 510 and two pointing needles 520, 530. Unlike the C-shaped ring 310 of the analog meter 300, the C-shaped ring 510 of the analog meter 500 is curved rightward. The pointing needles 520, 530 of the analog meter 500 are rotated in a region surrounded by the C-shaped ring 510. With regard to the present embodiment, the second frame is exemplified by the C-shaped ring 510.

The pointing needle 320 of the analog meter 300 and the pointing needles 520, 530 of the analog meter 500 are mechanically connected to the drive unit 700 via the dial plate 400. The drive unit 700 rotates the pointing needles 320, 520, 530 in response to a running condition (such as a vehicular speed, an engine speed, water temperature, or an amount of remaining fuel) of a vehicle on which the display device 100A is mounted.

The drive unit 700 may generate an image signal in response to the running condition of the vehicle on which the display device 100A is mounted, the image signal representing the meter image MTJ described with reference to FIG. 4. The image signal is output from the drive unit 700 to the display panel 200. The display panel 200 displays the meter image MTJ on the display surface 220 in response to the image signal.

Like the analog meters 300, 500, the circular ring 600 is mounted on the second surface 412 of the dial plate 400. The circular ring 600 is situated between the analog meters 300, 500.

The circular ring 600 includes a frame ring 610 and a light transmissive ring 620. The frame ring 610 includes an outer perimeter 611 and an inner perimeter 612. The outer perimeter 611 surrounds the inner perimeter 612. The light transmissive ring 620 includes an outer perimeter 621 and an inner perimeter 622. The outer perimeter 621 surrounds the inner perimeter 622.

The light transmissive ring 620 is situated in the frame ring 610. The outer perimeter 621 of the light transmissive ring 620 comes into contact with the inner perimeter 612 of the frame ring 610. The inner perimeter 622 of the light transmissive ring 620 coincides with the conceptual circle MDC described with reference to FIG. 4. Therefore, the circular ring 600 surrounds the meter image MTJ described with reference to FIG. 4. With regard to the present embodiment, the ring band is exemplified by the circular ring 600.

A designer designing the display device 100A may form the frame ring 610 of a non-transparent material (such as metal or resin). In this case, a driver may easily and visually recognize a region surrounded by the frame ring 610 as a region for displaying the running condition of the vehicle. Therefore, the circular ring 600 functions as a meter device in cooperation with the meter image MTJ described with reference to FIG. 4.

The designer designing the display device 100A may form the light transmissive ring 620 of a transparent material (such as resin). In this case, the circular ring 600 does not unnecessarily impair transmission of image light which is emitted from the display surface 220.

The meter vessel 810 is a tubular member which forms a space in which the display panel 200, the analog meters 300, 500, the dial plate 400, the circular ring 600 and the drive unit 700 are stored. The protection plate 820 closes an opening of the meter vessel 810. The display panel 200, the analog meters 300, 500, the dial plate 400 and the circular ring 600 are situated between the drive unit 700 and the protection plate 820 within the meter vessel 810.

The protection plate 820 is transparent as a whole. Therefore, image light generated by the display panel 200 reaches the protection plate 820 through a region in the rectangular frame DRF of the dial plate 400, and then incident to the driver's eyes. An optical treatment for suppressing reflection may be applied to the protection plate 820. In this case, the driver may visually recognize an image displayed on the display panel 200 without being impaired by reflection on the protection plate 820.

As described above, with regard to the present embodiment, the ring band is exemplified by the circular ring 600. Alternatively, a designer designing the display device 100A may provide another shape to the ring band (such as an oval or polygonal closed loop or a closed loop including an arc and a straight line). Therefore, the principles of the present embodiment are not limited to a specific shape of the ring band.

With regard to the present embodiment, the circular ring 600 exemplified as the ring band is constituted by two or more members (i.e. the frame ring 610 and the light transmissive ring 620). Alternatively, the ring band may be constituted by one member. Therefore, the principles of the present embodiment are not limited to a specific structure of the ring band.

As described above, with regard to the present embodiment, the first and second frames are exemplified by the C-shaped rings 310, 510, each of which forms a C-shaped arcuate contour. Alternatively, a designer designing a vehicular display device may provide another shape (such as a curved shape constituted by short line segments) to the first and/or second frames. Therefore, the principles of the present embodiment are not limited to a specific shape of the first and/or second frames.

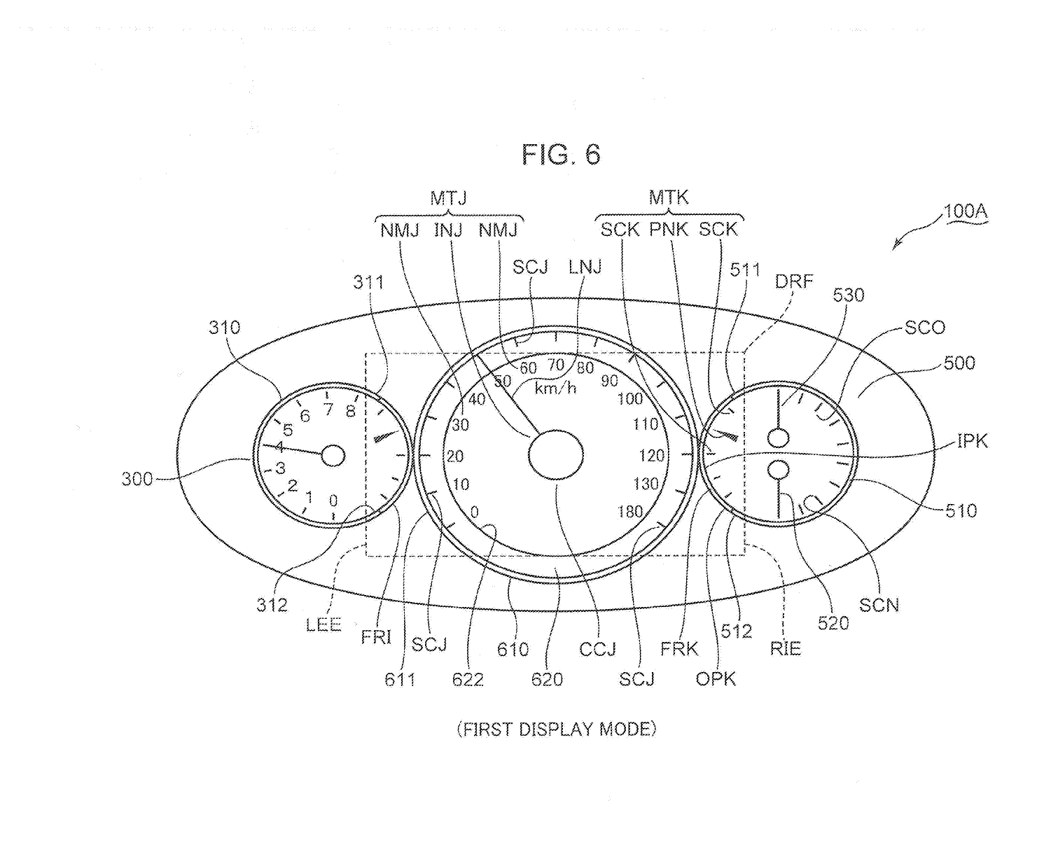

FIG. 6 is a schematic front view of the display device 100A. The display device 100A is further described with reference to FIGS. 5 and 6.

As described in the context of the first embodiment, the display panel 200 displays the frame image FRI. The frame image FRI is in contact with the frame ring 610. The expression “the frame image FRI is in contact with the frame ring 610” does not only mean that the frame image FRI is in contact with the outer perimeter 611 of the frame ring 610 at one point. As far as the driver visually recognizes that the frame image FRI is in contact with the frame ring 610, the frame image FRI is in contact with the frame ring 610.

The C-shaped ring 510 includes an upper end 511 and a lower end 512. The lower end 512 is spaced below from the upper end 511.

The upper and lower ends 311, 312 of the left-side C-shaped ring 310 are aligned along the left edge LEE of the rectangular frame DRF, which corresponds to the display surface 220 of the display panel 200 whereas the upper and lower ends 511, 512 of the right-side C-shaped ring 510 are aligned along the right edge RIE of the rectangular frame DRF. The C-shaped ring 510 is curved in a direction away from the rectangular frame DRF (i.e. rightward) between the upper and lower ends 511, 512. With regard to the present embodiment, the second edge is exemplified by the right edge 224 (c.f. FIG. 5) of the display surface 220 (c.f. FIG. 5), which corresponds to the right edge RIE of the rectangular frame DRF. The third end is exemplified by one of the upper and lower ends 511, 512. The fourth end is exemplified by the other of the upper and lower ends 511, 512.

The display panel 200 displays a frame image FRK. The frame image FRK is curved in a direction opposite to the C-shaped ring 510 (i.e. leftward). The frame image FRK extends from the upper end 511 of the C-shaped ring 510 to the lower end 512 of the C-shaped ring 510. Therefore, the frame image FRK forms a closed loop in cooperation with the C-shaped ring 510. The driver may watch information displayed in the closed loop to confirm a running condition of the vehicle. Like the frame image FRI, the frame image FRK is in contact with the frame ring 610. With regard to the present embodiment, the second frame image is exemplified by the frame image FRK.

Indexes SCN, SCO representing running conditions of the vehicle are drawn on the dial plate 400 in addition to the indexes SCM described in the context of the second embodiment. The index SCN represents a running condition of the vehicle in cooperation with the pointing needle 520. The index SCO represents a running condition of the vehicle in cooperation with the pointing needle 530. Like the indexes SCM, each of the indexes SCN, SCO may include scale lines or numbers. The principles of the present embodiment are not limited to a specific design of the indexes SCN, SCO.

The display panel 200 displays a meter image MTK in addition to the frame image FRK. The meter image MTK includes scale line images SCK and a needle point image PNK. The frame image FRK includes an inner perimeter image IPK and an outer perimeter image OPK. The inner perimeter image IPK is curved in a direction opposite to the C-shaped ring 510 between the upper and lower ends 511, 512. The outer perimeter image OPK is curved in a direction opposite to the C-shaped ring 510 between the upper and lower ends 511, 512 outside the inner perimeter image IPK.

The scale line images SCK are aligned along the inner perimeter image IPK substantially at regular intervals. Each of the scale line images SCK extends toward the center of curvature of the C-shaped ring 510. The pointing needle image PNK circularly moves along the inner perimeter image IPK in response to a running condition of the vehicle. The driver may confirm the running condition of the vehicle on the basis of a position of the pointing needle image PNK.

Scale lines SCJ are put onto the light transmissive ring 620. The scale lines SCJ may be formed by coating paint. Alternatively, the scale lines SCJ may be formed by engraving in a surface of the light transmissive ring 620. The principles of the present embodiment are not limited to a specific technique for forming the scale lines SCJ.

Each of the scale lines SCJ extends in a radial direction of the outer perimeter 611 of the frame ring 610. The scale lines SCJ are aligned in a circumferential direction of the outer perimeter 611. The scale lines SCJ may be arranged substantially at regular intervals.

The meter image MTJ described in the context of the third embodiment is displayed between the frame images FRI, FRK. The meter image MTJ includes number images NMJ and a pointing needle image INJ. Each of the number images NMJ represents a numerical value indicating a running condition of the vehicle. The number images NMJ are aligned along the inner perimeter 622 of the light transmissive ring 620.

The pointing needle image INJ includes a circular center image CCJ and a linear needle image LNJ. The center image CCJ is substantially concentric with the inner perimeter 622. The needle image LNJ extends from the center image CCJ toward the inner perimeter 622.

The number images NMJ are arranged in correspondence to the scale lines SCJ put onto the light transmissive ring 620, respectively. Each of the number images NMJ is displayed on a straight line connecting between each of the scale lines SCJ and the center image CCJ.

The display panel 200 changes an extending direction of the needle image LNJ from the center image CCJ in response to a change in the running condition of the vehicle. Therefore, the needle image LNJ swings around the center of a region surrounded by the inner perimeter 622. The driver may read a numerical value represented by one of the number images NMJ, which is situated in the extending direction of the needle image LNJ, to grasp the running condition of the vehicle.

### Fifth Embodiment

A vehicular display device may switch a display mode between a first display mode, in which the first frame image is displayed, and a second display mode, in which the first frame image is not displayed. An exemplary vehicular display device for switching the display mode is described in the fifth embodiment.

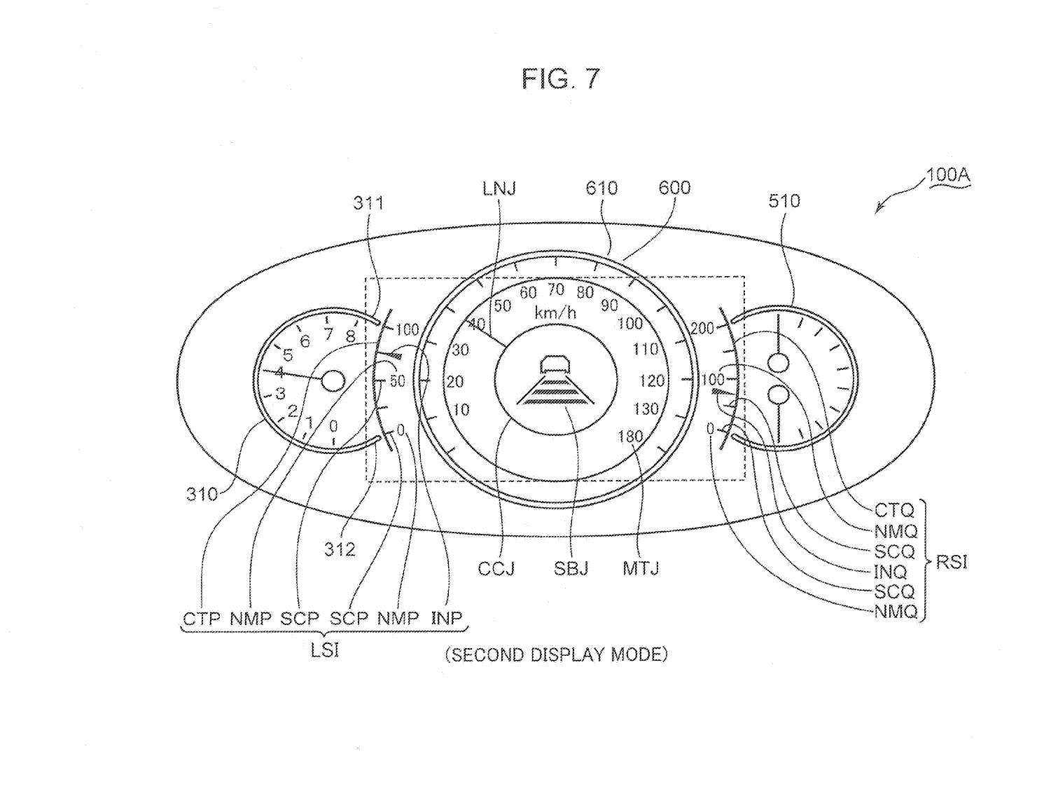

FIG. 7 is a schematic front view of the display device 100A. Reference numerals used in common between the fourth and fifth embodiments mean that elements indicated with the same reference numerals have the same functions as the fourth embodiment. Therefore, the description of the fourth embodiment is applicable to these elements. In the following description, the display mode shown in FIG. 6 is referred to as the “first display mode”. The display mode shown in FIG. 7 is referred to as the “second display mode”. The display device 100A is described with reference to FIGS. 5 to 7.

When a driver wants to change settings about a running condition of a vehicle, the driver may instruct the display device 100A to switch the display mode from the first display mode to the second display mode. In the present embodiment, the driver instructs to switch the display mode from the first display mode to the second display mode in order to determine settings about automatic cruise control. Therefore, FIG. 7 shows a set image for use in settings about the automatic cruise control. The display panel 200 may display an image in the second display mode, the image being used for another purpose. The principles of the present embodiment are not limited to a specific purpose of the second display mode.

The display panel 200 displays a symbol image SBJ representing that the set image about the automatic cruise control is displayed in the center image CCJ in the second display mode. Therefore, the driver may watch the symbol image SBJ in the center image CCJ to confirm whether or not a driver's request is appropriately transmitted from the driver to the display device 100A.

Like the first display mode, the display panel 200 displays the needle image LNJ extending from the center image CCJ. Therefore, the driver may appropriately grasp the running condition of the vehicle in the second display mode as well.

As described above, with regard to the present embodiment, display contents of the meter image MTJ are changed between the first and second display modes (whether or not the symbol image SBJ is present). Alternatively, the display contents of the meter image MTJ may be consistent between the first and second display modes. Therefore, the principles of the present embodiment are not specifically limited by a display pattern of the meter image MTJ.

When the display mode is switched from the first display mode to the second display mode, the display panel 200 displays the index image LSI instead of the frame image FRI. Like the frame image FRI, the index image LSI is displayed between the frame ring 610 and the C-shaped ring 310.

With regard to the present embodiment, the index image LSI represents settings about a distance between the vehicle, on which the display device 100A is mounted, and a preceding vehicle as a target in the automatic cruise control. The index image LSI includes a contour image CTP, scale line images SCP, number images NMP and a pointing needle image INP. The contour image CTP is curved toward the center of curvature of the C-shaped ring 310 between the upper and lower ends 311, 312 of the C-shaped ring 310. The scale line images SCP and the number images NMP are aligned along the curved contour image CTP. A position of the pointing needle image INP is changed along the contour image CTP in response to a setting operation by the driver. The driver may watch the position of the pointing needle image INP to determine settings about an inter-vehicle distance.

The change in the display position of the pointing needle image INP may rely on existing techniques about automatic cruise control and existing image signal processing techniques. Therefore, the principles of the present embodiment are not limited to a specific technique for setting an inter-vehicle distance.

When the display mode is switched from the first display mode to the second display mode, the display panel 200 displays an index image RSI instead of the frame image FRK. Like the frame image FRK, the index image RSI is displayed between the frame ring 610 and the C-shaped ring 510.

With regard to the present embodiment, the index image RSI represents settings of a maximum vehicular speed in the automatic cruise control. The index image RSI includes a contour image CTQ, scale line images SCQ, number images NMQ and a pointing needle image INQ. The contour image CTQ is curved toward the center of curvature of the C-shaped ring 510 between the upper and lower ends 511, 512 of the C-shaped ring 510. The scale line images SCQ and the number images NMQ are aligned along the curved contour image CTQ. A position of the pointing needle image INQ is changed along the contour image CTQ in response to a setting operation by the driver. The driver may watch the position of the pointing needle image INQ to determine settings about a maximum vehicular speed in the automatic cruise control.

The change in the display position of the pointing needle image INQ may rely on existing techniques about automatic cruise control and existing image signal processing techniques. Therefore, the principles of the present embodiment are not limited to a specific technique for setting a maximum vehicular speed.

The contour images CTP, CTQ may be concentric with the frame ring 610. The expression “the contour images CTP, CTQ are concentric with the frame ring 610” does not only mean that the center of curvature of each of the contour images CTP, CTQ completely coincides with the center of the frame ring 610. As far as the driver visually recognizes that the center of curvature of each of the contour images CTP, CTQ coincides with the center of the frame ring 610, the contour images CTP, CTQ are concentric with the frame ring 610.

If the contour images CTP, CTQ are concentric with the frame ring 610, the index images LSI, RSI provide the driver with unified visual impressions of the index images LSI, RSI with the circular ring 600 and the meter image MTJ in the circular ring 600.

### Sixth Embodiment

The vehicular display device described in the context of the fifth embodiment is driven by the drive unit. A designer may provide various structures to the drive unit. An exemplary structure of the drive unit is described in the sixth embodiment.

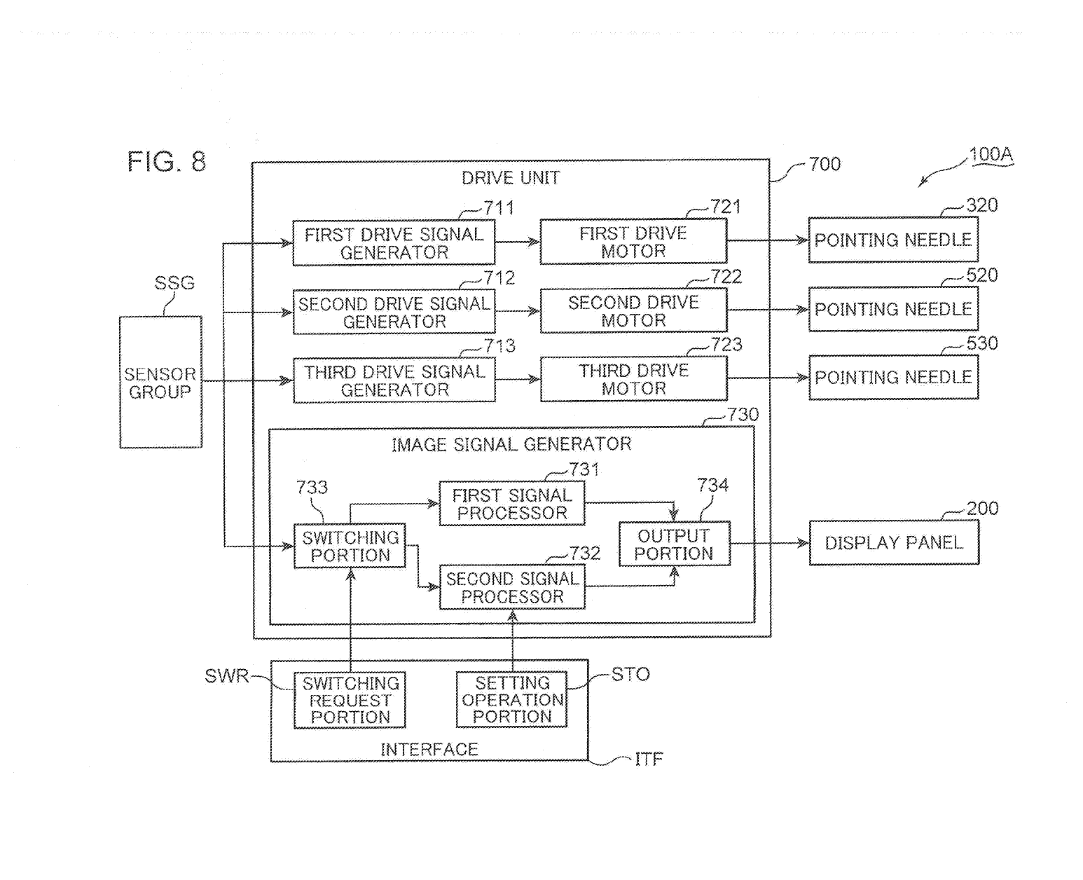

FIG. 8 is a block diagram conceptually showing a signal flow in the display device 100A. Reference numerals used in common between the fifth and sixth embodiments mean that elements indicated with the same reference numerals have the same functions as the fifth embodiment. Therefore, the description of the fifth embodiment is applicable to these elements. The display device 100A is described with reference to FIGS. 5 to 8.

The drive unit 700 includes a first drive signal generator 711, a second drive signal generator 712, a third drive signal generator 713, a first drive motor 721, a second drive motor 822, a third drive motor 723 and an image signal generator 730. The first drive signal generator 711 is electrically connected to the first drive motor 721. The first drive motor 721 is mechanically connected to the pointing needle 320. The second drive signal generator 712 is electrically connected to the second drive motor 722. The second drive motor 722 is mechanically connected to the pointing needle 520. The third drive signal generator 713 is electrically connected to the third drive motor 723. The third drive motor 723 is mechanically connected to the pointing needle 530. The image signal generator 730 is electrically connected to the display panel 200.

Various sensor devices (not shown) for detecting physical amounts which depend on a running condition of a vehicle (such as a vehicular speed, an engine speed, water temperature or an amount of remaining fuel) are situated in the vehicle. A sensor group SSG includes these sensor devices. The sensor group SSG generates various detection signals representing various physical amounts. These detection signals are output from the sensor group SSG to the first drive signal generator 711, the second drive signal generator 712, the third drive signal generator 713 and the image signal generator 730, respectively. The sensors constituting the sensor group SSG may be what are used in an existing vehicle. Therefore, the principles of the present embodiment are not limited to a specific sensor of the sensor group SSG.

The first drive signal generator 711 receives a detection signal representing a physical amount, which corresponds to an index designated by the pointing needle 320. The first drive signal generator 711 generates a drive signal in response to the detection signal. The drive signal is output from the first drive signal generator 711 to the first drive motor 721. The first drive motor 721 is rotated in response to the drive signal. Consequently, the pointing needle 320 may rotate on the dial plate 400.

The second drive signal generator 712 receives a detection signal representing a physical amount, which corresponds to an index designated by the pointing needle 520. The second drive signal generator 712 generates a drive signal in response to the detection signal. The drive signal is output from the second drive signal generator 712 to the second drive motor 722. The second drive motor 722 is rotated in response to the drive signal. Consequently, the pointing needle 520 may rotate on the dial plate 400.

The third drive signal generator 713 receives a detection signal representing a physical amount, which corresponds to an index designated by the pointing needle 530. The third drive signal generator 713 generates a drive signal in response to the detection signal. The drive signal is output from the third drive signal generator 713 to the third drive motor 723. The third drive motor 723 is rotated in response to the drive signal. Consequently, the pointing needle 530 may rotate on the dial plate 400.

Conversion from a detection signal to a drive signal may rely on various signal processing techniques which are used in an existing analog meter. Therefore, the principles of the present embodiment are not limited to a specific signal processing technique for converting a detection signal to a drive signal.

An interface ITF for requesting manual switching of the display mode between the first and second display modes is mounted on the vehicle. The interface ITF may be a lever, a button, or a dial provided near a steering wheel of the vehicle. The principles of the present embodiment are not limited to a specific structure of the interface ITF.

The interface ITF includes a switching request portion SWR and a setting operation portion STO. A driver operates the switching request portion SWR to request switching of the display mode between the first and second display modes. The driver may operate the setting operation portion STO in the second display mode to determine settings about automatic cruise control.

The image signal generator 730 includes a first signal processor 731, a second signal processor 732, a switching portion 733 and an output portion 734. A detection signal corresponding to a physical amount represented by the meter image MTJ is output from the sensor group SSG to the switching portion 733. The switching request portion SWR generates a switching signal in response to a driver's operation. The switching signal is output from the switching request portion SWR to the switching portion 733.

The switching portion 733 determines an output destination of the detection signal in response to the switching signal. When the switching signal indicates a request for switching from the second display mode to the first display mode, the switching portion 733 outputs the detection signal to the first signal processor 731. The first signal processor 731 generates an image signal for representing the image described with reference to FIG. 6. When the switching signal indicates a request for switching from the first display mode to the second display mode, the switching portion 733 outputs the detection signal to the second signal processor 732. The second signal processor 732 generates an image signal for representing the image described with reference to FIG. 7.

The setting operation portion STO generates a setting signal representing settings about the automatic cruise control (an inter-vehicle distance and a maximum vehicular speed in the automatic cruise control) in response to a driver's operation. The setting signal is output from the setting operation portion STO to the second signal processor 732. The second signal processor 732 determines display positions of the pointing needle images INP, INQ in response to the setting signal.

The output portion 734 receives the image signal generated by the first or second signal processor 731, 732. The image signal is then output from the output portion 734 to the display panel 200. The display panel 200 displays the image described reference to FIG. 6 or FIG. 7 in response to the image signal.

The signal processing techniques about image display may rely on various existing image generating techniques. Therefore, the principles of the present embodiment are not limited to a specific signal processing technique for displaying an image.

The first drive signal generator 711, the second drive signal generator 712, the third drive signal generator 713 and the image signal generator 730 may be a general IC chip or another electric element which is used for processing signals. Therefore, the principles of the present embodiment are not limited to specific electric elements used as the first drive signal generator 711, the second drive signal generator 712, the third drive signal generator 713 and the image signal generator 730.

The principles of the aforementioned embodiments may be combined so as to meet requirements for a vehicle.

An exemplary vehicular display device described in the context of the aforementioned embodiments mainly includes the following features.

A vehicular display device according to one aspect of the aforementioned embodiments is mounted on a vehicle. The vehicular display device has a display panel including a display surface on which an image is displayed, and a housing, which supports the display surface; and a first analog meter including a first frame curved in a direction away from the display surface between a first end and a second end, which are aligned along a boundary line between the display surface and the housing. The display panel displays a first frame image curved in a direction opposite to the first frame. The first frame image extends from the first end to the second end.

According to the aforementioned configuration, since the vehicular display device includes the display panel and the first analog meter, the vehicular display device provides information to a driver without completely depending on the display panel. Therefore, a designer may use a device having a small display area as a display panel.

Since the first frame image curved in a direction opposite to the first frame extends from the first end of the first frame to the second end of the first frame, the first frame and the first frame image may give the first analog meter substantially the same outer contour as a general analog meter. Accordingly, the vehicular display device may display an image in such a manner which is familiar to a driver.

With regard to the aforementioned configuration, the display surface may include a first display region, in which the first frame image is displayed, and a second display region adjacent to the first display region. The second display region may include a meter display region, in which a meter image is displayed, the meter image representing a running condition of the vehicle.

According to the aforementioned configuration, since the second display region includes the meter display region, in which the meter image is displayed, the meter image representing a running condition of the vehicle, the vehicular display device may use a display panel to transmit information about the running condition of the vehicle to the driver.

With regard to the aforementioned configuration, the display panel may switch a display mode between a first display mode, in which the first frame image is displayed, and a second display mode, in which an index image is displayed, the index image being curved toward a center of curvature of the first frame between the first and second ends.

According to the aforementioned configuration, since the display panel switches the display mode between the first and second display modes, the vehicular display device provides a variety of information to the driver.

With regard to the aforementioned configuration, the vehicular display device may further include a ring band, which surrounds the meter display region. The ring band may function as a meter device which indicates the running condition of the vehicle in cooperation with the meter image.

According to the aforementioned configuration, since the ring band surrounding the meter display region functions as a meter device which indicates the running condition of the vehicle in cooperation with the meter image, the ring band and the meter image give the driver visual impressions analogous to a general analog meter. Accordingly, the vehicular display device may display information in such a manner which is familiar to the driver.

With regard to the aforementioned configuration, the display panel may display the first frame image so that the first frame image is in contact with the ring band.

According to the aforementioned configuration, since the display panel displays the first frame image so that the first frame image is in contact with the ring band, the vehicular display device may give the driver visual impressions analogous to a general meter device having analog meters. Accordingly, the vehicular display device may display information in such a manner which is familiar to the driver.

With regard to the aforementioned configuration, the index image may be concentric with the ring band.

According to the aforementioned configuration, since the index image is concentric with the ring band, the display panel may use a sophisticated image design to give the driver information.

With regard to the aforementioned configuration, the vehicular display device may further have a second analog meter including a second frame. The ring band may be situated between the first and second analog meters. The boundary line may include a first edge extending along the first and second ends, and a second edge opposite to the first edge The second frame may be curved in a direction away from the display surface between a third end and a fourth end, which are aligned along the second edge. The display panel may display a second frame image curved in a direction opposite to the second frame. The second frame image may extend from the third end to the fourth end.

According to the aforementioned configuration, since the ring band is situated between the first and second analog meters, visual impressions analogous to a general meter device in which analog meters are sequentially arranged are provided to the driver.

Since the second frame image curved in a direction opposite to the second frame extends from the third end of the second frame to the fourth end of the second frame, the second frame and the second frame image may give the second analog meter substantially the same outer contour as a general analog meter. Accordingly, the vehicular display device display information in such a manner which is familiar to the driver.

### INDUSTRIAL APPLICABILITY

The principles of the aforementioned embodiments are advantageously used in designing various vehicles.

1. A vehicular display device mounted on a vehicle, comprising:
a display panel including a display surface, on which an image is displayed, and a housing, which supports the display surface; and
a first analog meter including a first frame curved in a direction away from the display surface between a first end and a second end, which are aligned along a boundary line between the display surface and the housing,
wherein the display panel displays a first frame image curved in a direction opposite to the first frame, and
wherein the first frame image extends from the first end to the second end.

2. The vehicular display device according to claim 1,
wherein the display surface includes a first display region in which the first frame image is displayed, and a second display region adjacent to the first display region, and
wherein the second display region includes a meter display region, in which a meter image is displayed, the meter image representing a running condition of the vehicle.

3. The vehicular display device according to claim 2,
wherein the display panel switches a display mode between a first display mode, in which the first frame image is displayed, and a second display mode, in which an index image is displayed, the index image being curved toward a center of curvature of the first frame between the first end and the second end.

4. The vehicular display device according to claim 3, further comprising:
a ring band which surrounds the meter display region,
wherein the ring band functions as a meter device which indicates the running condition of the vehicle in cooperation with the meter image.

5. The vehicular display device according to claim 4,
wherein the display panel displays the first frame image so that the first frame image is in contact with the ring band.

6. The vehicular display device according to claim 5,
wherein the index image is concentric with the ring band.

7. The vehicular display device according to claim 4, further comprising:
a second analog meter including a second frame,
wherein the ring band is situated between the first and second analog meters,
wherein the boundary line includes a first edge extending along the first and second ends, and a second edge opposite to the first edge,
wherein the second frame is curved in a direction away from the display surface between a third end and a fourth end, which are aligned along the second edge,
wherein the display panel displays a second frame image curved in a direction opposite to the second frame, and
wherein the second frame image extends from the third end to the fourth end.

8. The vehicular display device according to claim 5, further comprising:
a second analog meter including a second frame,
wherein the ring band is situated between the first and second analog meters,
wherein the boundary line includes a first edge extending along the first and second ends, and a second edge opposite to the first edge,
wherein the second frame is curved in a direction away from the display surface between a third end and a fourth end, which are aligned along the second edge,
wherein the display panel displays a second frame image curved in a direction opposite to the second frame, and
wherein the second frame image extends from the third end to the fourth end.

9. The vehicular display device according to claim 6, further comprising:
a second analog meter including a second frame,
wherein the ring band is situated between the first and second analog meters,
wherein the boundary line includes a first edge extending along the first and second ends, and a second edge opposite to the first edge,
wherein the second frame is curved in a direction away from the display surface between a third end and a fourth end, which are aligned along the second edge,
wherein the display panel displays a second frame image curved in a direction opposite to the second frame, and
wherein the second frame image extends from the third end to the fourth end.

10. The vehicular display device according to claim 4,
wherein a part of the meter display region surrounded by the ring band is used to show that the display mode is the second display mode to determine a setting for automatic cruise control when the first display mode is changed into the second display mode,
wherein the display panel switches the image from the first frame image to the index image when the first display mode is changed into the second display mode, the first frame image and the index image being selectively displayed between the ring band and the first frame, and
wherein the index image shows an inter-vehicle distance to be set in front of the vehicle under the automatic cruise control.
